(19) United States
(12) Patent Application Publication
(10) Pub. No.: US 2024/0200884 A1
(43) Pub. Date: Jun. 20, 2024

(54) HEAT EXCHANGER

(71) Applicant: NGK INSULATORS, LTD., Nagoya-City (JP)

(72) Inventors: Ryushiro AKAISHI, Nagoya-Shi (JP); Tatsuo KAWAGUCHI, Mizuho-Shi (JP); Shinnosuke IWASAKI, Komaki-Shi (JP)

(73) Assignee: NGK INSULATORS, LTD., Nagoya-City (JP)

(21) Appl. No.: 18/510,818

(22) Filed: Nov. 16, 2023

(30) Foreign Application Priority Data
Dec. 20, 2022 (JP) 2022-203648

(51) Int. Cl. F28D 21/00; F28D 7/10; F28F 1/02

(52) U.S. Cl. CPC F28D 21/0001; F28D 7/103; F28F 1/022

(57) ABSTRACT

A heat exchanger includes: a hollow heat recovery member having an inner peripheral surface and an outer peripheral surface in an axial direction, and an inflow end face and an outflow end face for a first fluid in a direction perpendicular to the axial direction; a first outer cylindrical member having an inflow port and an outflow port for the first fluid; a first inner cylindrical member having an inflow port and an outflow port for the first fluid, the first inner cylindrical member being fitted to the inner peripheral surface of the heat recovery member; and a second inner cylindrical member having an inflow port and an outflow port for the first fluid, the outflow port being located on an upstream side of the inflow end face of the heat recovery member based on the flow direction of the first fluid as a reference.

### CROSS REFERENCE TO RELATED APPLICATIONS

The present invention claims the benefit of priority to Japanese Patent Application No 2022-203648 filed on Dec. 20, 2022 with the Japanese Patent Office, the entire contents of which are incorporated herein by reference in its entirety.

### FIELD OF THE INVENTION

The present invention relates to a heat exchanger.

### BACKGROUND OF THE INVENTION

Recently, there is a need for improvement of fuel economy of motor vehicles. In particular, a system is expected that worms up a coolant, engine oil and an automatic transmission fluid (ATF: Automatic Transmission Fluid) at an early stage to reduce friction losses, in order to prevent deterioration of fuel economy at the time when an engine is cold, such as when the engine is started. Further, a system is expected that heats an exhaust gas purifying catalyst in order to activate the catalyst at an early stage.

As one of the systems as described above, for example, there is a heat exchanger. The heat exchanger is a device that exchanges heat between a first fluid and a second fluid by allowing the first fluid to flow inside and the second fluid to flow outside. In such a heat exchanger, for example, the heat can be effectively utilized by exchanging the heat from the first fluid having a higher temperature (for example, an exhaust gas) to the second fluid having a lower temperature (for example, cooling water).

The heat exchanger preferably has a function capable of switching between a mode where heat is recovered (hereinafter referred to as a “heat recovery mode”) and a mode where heat is not recovered (hereinafter referred to as a “non-heat recovery mode”) in terms of proper heat management. The non-heat recovery mode is generally applied after the warm-up is completed.

A heat exchanger including a heat exchange portion that exchanges heat with an exhaust gas and a bypass route through which an exhaust gas bypasses the heat exchange portion is known as the heat exchanger capable of switching between the heat recovery mode and the non-heat recovery mode (e.g., Patent Literature 1).

Since the heat exchanger preferably has a small size in view of a space required for installation in an automobile, a heat exchanger having a structure in which a heat exchange portion is provided around a circumference of a cylindrical member is also known in the art (e.g., Patent Literatures 2 and 3).

Furthermore, in Patent Literature 4, the Applicant proposed a heat exchanger structure that can improve heat recovery performance while reducing an impact on pressure loss (flow path resistance) during the heat recovery mode and improve heat shielding performance during the non-heat recovery mode.

In the heat exchanger described in Patent Literature 4, the outflow port of the second inner cylindrical member (second inner cylinder) is located closer to the outflow end face side than the inflow end face of the hollow pillar shaped honeycomb structure in the axial direction of the hollow pillar shaped honeycomb structure. Therefore, during the heat recovery mode, the flow of the first fluid (exhaust gas) flowing into the second inner cylindrical member is turned back to the opposite side, so that an increase in pressure loss (flow path resistance) cannot be sufficiently suppressed. The increase in pressure loss causes a large load in the heat exchanger, and in some cases, it may lead to breakage or bursting of the heat exchanger.

The present invention has been made to solve the above problems. An object of the present invention is to provide a heat exchanger capable of improving heat recovery performance while suppressing an increase in pressure loss (flow path resistance) during the heat recovery mode and improving heat shielding performance during the non-heat recovery mode.

### PRIOR ART

### Patent Literatures

[Patent Literature 1] WO 2016/140068 A1
[Patent Literature 2] Japanese Patent Application Publication No. 2020-84860 A
[Patent Literature 3] Japanese Patent No. 6761424 B
[Patent Literature 4] Japanese Patent Application Publication No. 2020-159270 A

### SUMMARY OF THE INVENTION

Based on the structure of the heat exchanger described in Patent Literature 4, the present inventors have further studied the structure, and as a result, they have found that the above problems can be solved by arranging the outflow port of the second inner cylindrical member at a specific position, and completed the present invention. Thus, the present invention is illustrated as follows:

(1)

A heat exchanger, comprising:
a hollow heat recovery member having an inner peripheral surface and an outer peripheral surface in an axial direction, and an inflow end face and an outflow end face for a first fluid in a direction perpendicular to the axial direction;
a first outer cylindrical member having an inflow port and an outflow port for the first fluid, the first outer cylindrical member being fitted to the outer peripheral surface of the heat recovery member;
a first inner cylindrical member having an inflow port and an outflow port for the first fluid, the first inner cylindrical member being fitted to the inner peripheral surface of the heat recovery member, wherein the inflow port is located between the inflow end face and the outflow end face of the heat recovery member, based on a flow direction of the first fluid as a reference; and
a second inner cylindrical member having an inflow port and an outflow port for the first fluid, the outflow port being located on an upstream side of the inflow end face of the heat recovery member based on the flow direction of the first fluid as a reference, wherein the second inner cylindrical member has a portion arranged at a space so as to form a flow path for the first fluid on a radially inner side of the first outer cylindrical member;
wherein the outflow port of the second inner cylindrical member has an inner diameter smaller than that of the inflow port of the first inner cylindrical member,
wherein a ratio L2/L1 of a flow direction length L2 from the outflow port of the second inner cylindrical member to a position corresponding to an upstream end portion of a space region between the first outer cylindrical member and the second inner cylindrical member formed on an upstream side of the inflow end face of the heat recovery member, to a flow direction length L1 of the space region is 0.05 to 0.95, based on the flow direction of the first fluid as a reference.
   (2)

The heat exchanger according to (1), further comprising a ring-shaped member for connecting the inflow port side of the first outer cylindrical member to the second inner cylindrical member so as to form the flow path for the first fluid.

(3)

A heat exchanger, comprising:
a hollow heat recovery member having an inner peripheral surface and an outer peripheral surface in an axial direction, and an inflow end face and an outflow end face for a first fluid in a direction perpendicular to the axial direction;
a first outer cylindrical member having an inflow port and an outflow port for the first fluid, the first outer cylindrical member being fitted to the outer peripheral surface of the heat recovery member;
a first inner cylindrical member having an inflow port and an outflow port for the first fluid, the first inner cylindrical member being fitted to the inner peripheral surface of the heat recovery member, wherein at least one through hole for introducing the first fluid to the inflow end face of the heat recovery member is provided on an upstream side of the inflow end face of the heat recovery member, based on a flow direction of the first fluid as a reference; and
a second inner cylindrical member having an inflow port and an outflow port for the first fluid, the outflow port being located on a radially inner side of the first inner cylindrical member and on an upstream side of a downstream end portion of the through hole of the first inner cylindrical member, based on the flow direction of the first fluid as a reference;
wherein an end portion of the first inner cylindrical member on the inflow port side is connected to the first outer cylindrical member and/or the second inner cylindrical member,
wherein a ratio L4/L3 of a flow direction length L4 from the outflow port of the second inner cylindrical member to a position corresponding to an upstream end portion of a space region between the first outer cylindrical member and the first inner cylindrical member formed on an upstream side of the inflow end face of the heat recovery member, to a flow direction length L3 of the space region is 0.05 to 0.95, based on the flow direction of the first fluid as a reference.
   (4)

The heat exchanger according to (3), further comprising a ring-shaped member for connecting the inflow port side of the first outer cylindrical member to the inflow port side of the first inner cylindrical member and/or the second inner cylindrical member so as to form the flow path for the first fluid.

(5)

The heat exchanger according to any one of (1) to (4), further comprising a tubular member connected to the outflow port side of the first outer cylindrical member, the tubular member having a portion arranged at a space so as to form the flow path for the first fluid on a radially outer side of the first inner cylindrical member.

(6)

The heat exchanger according to any one of (1) to (5), wherein the second inner cylindrical member has a streamlined structure having a diameter gradually decreasing toward the outflow port.

(7) The heat exchanger according to any one of (1) to (6), wherein the outflow port of the second inner cylindrical member is polygonal or elliptical.
(8)

The heat exchanger according to any one of (1) to (7), wherein the heat recovery member is a hollow pillar shaped honeycomb structure having an inner peripheral wall, an outer peripheral wall, and a partition wall arranged between the inner peripheral wall and the outer peripheral wall, the partition wall defining a plurality of cells each extending from the inflow end face to the outflow end face to form a flow path for the first fluid.

(9)

The heat exchanger according to any one of (1) to (8), further comprising a second outer cylindrical member arranged on a radially outer side of the first outer cylindrical member at a space, wherein a second fluid can be allowed to flow between the second outer cylindrical member and the first outer cylindrical member.

(10)

The heat exchanger according to any one of (1) to (9), further comprising an on-off valve arranged on the outflow port side of the first inner cylindrical member.

### BRIEF DESCRIPTION OF THE DRAWINGS

FIG. 1A is a cross-sectional view of a heat exchanger according to Embodiment 1 of the present invention, which is parallel to a flow direction of a first fluid;

FIG. 1B is a cross-sectional view taken along the line a-a′ in the heat exchanger of FIG. 1A;

FIG. 2 is a cross-sectional view of another heat exchanger according to Embodiment 1 of the present invention, which is parallel to a flow direction of a first fluid;

FIG. 3A is a cross-sectional view of a heat exchanger according to Embodiment 2 according to the present invention, which is parallel to a flow direction of a first fluid;

FIG. 3B is a cross-sectional view taken along the line b-b′ in the heat exchanger of FIG. 3A; and

FIG. 4 is a cross-sectional view of another heat exchanger according to Embodiment 2 of the present invention, which is parallel to a flow direction of a first fluid.

### DETAILED DESCRIPTION OF THE INVENTION

A heat exchanger according to the present invention includes:
a hollow heat recovery member having an inner peripheral surface and an outer peripheral surface in an axial direction, and an inflow end face and an outflow end face for a first fluid in a direction perpendicular to the axial direction;
a first outer cylindrical member having an inflow port and an outflow port for the first fluid, the first outer cylindrical member being fitted to the outer peripheral surface of the heat recovery member;
a first inner cylindrical member having an inflow port and an outflow port for the first fluid, the first inner cylindrical member being fitted to the inner peripheral surface of the heat recovery member, wherein the inflow port is located between the inflow end face and the outflow end face of the heat recovery member, based on a flow direction of the first fluid as a reference; and
a second inner cylindrical member having an inflow port and an outflow port for the first fluid, the outflow port being located on an upstream side of the inflow end face of the heat recovery member based on the flow direction of the first fluid as a reference, wherein the second inner cylindrical member has a portion arranged at a space so as to form a flow path for the first fluid on a radially inner side of the first outer cylindrical member;
wherein the outflow port of the second inner cylindrical member has an inner diameter smaller than that of the inflow port of the first inner cylindrical member,
wherein a ratio L2/L1 of a flow direction length L2 from the outflow port of the second inner cylindrical member to a position corresponding to an upstream end portion of a space region between the first outer cylindrical member and the second inner cylindrical member formed on an upstream side of the inflow end face of the heat recovery member, to a flow direction length L1 of the space region is 0.05 to 0.95, based on the flow direction of the first fluid as a reference.

Also, the heat exchanger according to the present invention includes:
a hollow heat recovery member having an inner peripheral surface and an outer peripheral surface in an axial direction, and an inflow end face and an outflow end face for a first fluid in a direction perpendicular to the axial direction;
a first outer cylindrical member having an inflow port and an outflow port for the first fluid, the first outer cylindrical member being fitted to the outer peripheral surface of the heat recovery member;
a first inner cylindrical member having an inflow port and an outflow port for the first fluid, the first inner cylindrical member being fitted to the inner peripheral surface of the heat recovery member, wherein at least one through hole for introducing the first fluid to the inflow end face of the heat recovery member is provided on an upstream side of the inflow end face of the heat recovery member, based on a flow direction of the first fluid as a reference; and
a second inner cylindrical member having an inflow port and an outflow port for the first fluid, the outflow port being located on a radially inner side of the first inner cylindrical member and on an upstream side of a downstream end portion of the through hole of the first inner cylindrical member, based on the flow direction of the first fluid as a reference;
wherein an end portion of the first inner cylindrical member on the inflow port side is connected to the first outer cylindrical member and/or the second inner cylindrical member,
wherein a ratio L4/L3 of a flow direction length L4 from the outflow port of the second inner cylindrical member to a position corresponding to an upstream end portion of a space region between the first outer cylindrical member and the first inner cylindrical member formed on an upstream side of the inflow end face of the heat recovery member, to a flow direction length L3 of the space region is 0.05 to 0.95, based on the flow direction of the first fluid as a reference.

By configuring the heat exchanger according to the present invention as described above, the outflow port of the second inner cylindrical member will be located on an upstream side of the inflow end face of the hollow heat recovery member, so that the flow of the first fluid (exhaust gas) that has flowed out through the outflow port of the second inner cylindrical member can be prevented from being turned back during the heat recovery mode. Therefore, during the heat recovery mode, an increase in pressure loss (flow path resistance) can be sufficiently suppressed, so that breakage or rupture of the heat exchanger is difficult to occur. Also, the length of the second inner cylindrical member can be shortened, so that it is possible to reduce the weight and production cost of the heat exchanger. Further, the inner diameter of the outflow port of the second inner cylindrical member is made smaller than that of the inflow port of the first inner cylindrical member, so that the first fluid flowing out through the outflow port of the second inner cylindrical member tends to flow smoothly into the first inner cylindrical member during the non-heat recovery mode. Therefore, heat is difficult to be transferred to the hollow heat recovery member, so that the heat shielding performance can be improved.

Hereinafter, embodiments of the present invention will be specifically described with reference to the drawings. It is to understand that the present invention is not limited to the following embodiments, and those which appropriately added changes, improvements and the like to the following embodiments based on knowledge of a person skilled in the art without departing from the spirit of the present invention fall within the scope of the present invention.

### Embodiment 1

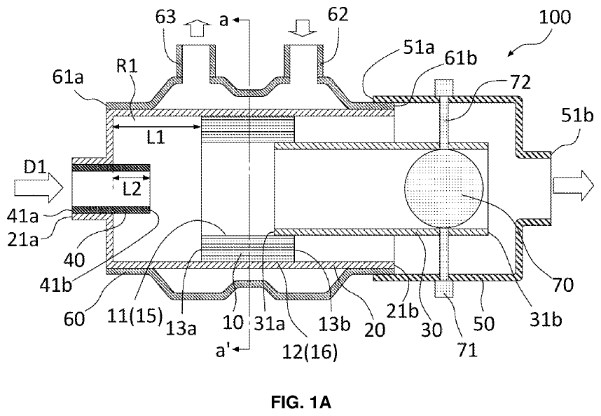

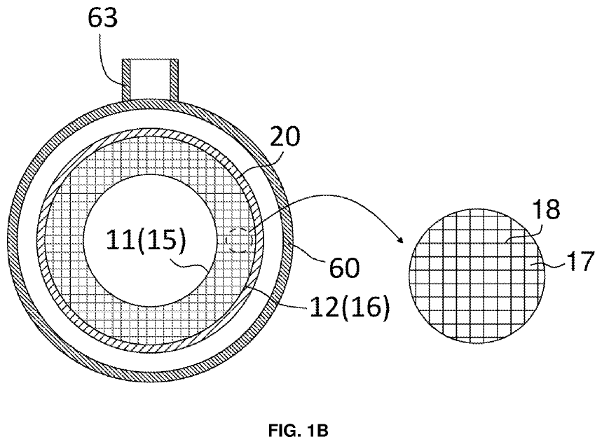

FIG. 1A is a cross-sectional view of a heat exchanger according to Embodiment 1 of the present invention, which is parallel to a flow direction of a first fluid. Further, FIG. 1B is a cross-sectional view taken along the line a-a′ in the heat exchanger of FIG. 1A.

As shown in FIGS. 1A and 1B, a heat exchanger 100 includes: a hollow heat recovery member 10; a first outer cylindrical member 20; a first inner cylindrical member 30; and a second inner cylindrical member. Also, the heat exchanger 100 may further include a tubular member 50, a second outer cylindrical member 60 and an on-off valve 70.

### (1. Hollow Heat Recovery Member)

The hollow heat recovery member 10 (which may, hereinafter, be abbreviated as a “heat recovery member 10”) has an inner peripheral surface 11 and an outer peripheral surface 12 in an axial direction, and an inflow end face 13a and an outflow end face 13b for a first fluid in a direction perpendicular to the axial direction. As used herein, the “heat recovery member 10” means a member having a function of recovering heat.

The heat recovery member 10 is not particularly limited as long as it has the structure as described above, and a known member in the art can be used.

From the viewpoint of heat recovery performance, the heat recovery member 10 is preferably a hollow pillar shaped honeycomb structure including: an inner peripheral wall 15, an outer peripheral wall 16, and a partition wall 18 which is disposed between the inner peripheral wall 15 and the outer peripheral wall 16, and which defines a plurality of cells 17 each extending from an inflow end face 13a to an outflow end face 13b to form a flow path for the first fluid, as shown in FIG. 1B.

As used herein, the “hollow pillar shaped honeycomb structure” refers to a pillar shaped honeycomb structure having a hollow region at a central portion in a cross section of the hollow pillar shaped honeycomb structure, which is perpendicular to a flow path direction of the first fluid.

A shape (outer shape) of the hollow pillar shaped honeycomb structure is not particularly limited, but it may be, for example, a cylindrical shape, an elliptical pillar shape, a quadrangular pillar shape, or other polygonal pillar shape.

Also, a shape of the hollow region in the hollow pillar shaped honeycomb structure is not particularly limited, but it may be, for example, a cylindrical shape, an elliptical pillar shape, a quadrangular pillar shape, or other polygonal pillar shape.

It should be note that the shape of the hollow pillar shaped honeycomb structure and the shape of the hollow region may be the same as or different from each other. However, they are preferably the same as each other, in terms of resistance to external impact, thermal stress, and the like.

Each cell 17 may have any shape, including, but not particularly limited to, circular, elliptical, triangular, quadrangular, hexagonal and other polygonal shapes in a cross section in a direction perpendicular to a flow path direction of the first fluid. Also, the cells 17 are radially provided in a cross section in a direction perpendicular to the flow path direction of the first fluid. Such a structure can allow heat of the first fluid flowing through the cells 17 to be efficiently transmitted to the outside of the hollow pillar shaped honeycomb structure.

A thickness of the partition wall 18 may preferably be from 0.1 to 1 mm, and more preferably from 0.2 to 0.6 mm, although not particularly limited thereto. The thickness of the partition wall 18 of 0.1 mm or more can provide the hollow pillar shaped honeycomb structure with a sufficient mechanical strength. Further, the thickness of the partition wall 18 of 1 mm or less can suppress problems that the pressure loss is increased due to a decrease in an opening area and the heat recovery efficiency is decreased due to a decrease in a contact area with the first fluid.

Each of the inner peripheral wall 15 and the outer peripheral wall 16 preferably has a thickness larger than that of the partition wall 18, although not particularly limited thereto. Such a structure can lead to increased strength of the inner peripheral wall 15 and the outer peripheral wall 16 which would otherwise tend to generate breakage (e.g., cracking, chinking, and the like) by external impact, thermal stress due to a temperature difference between the first fluid and the second fluid, and the like.

In addition, the thicknesses of the inner peripheral wall 15 and the outer peripheral wall 16 are not particularly limited, and they may be adjusted as needed according to applications and the like. For example, the thickness of each of the inner peripheral wall 15 and the outer peripheral wall 16 is preferably from 0.1 mm to 10 mm, and more preferably from 0.5 mm to 5 mm, and even more preferably from 1 mm to 3 mm, when using the heat exchange 100 for general heat exchange applications. Moreover, when using the heat exchanger 100 for heat storage applications, the thickness of the outer peripheral wall 16 is preferably 10 mm or more, in order to increase a heat capacity of the outer peripheral wall 16.

The partition wall 18, the inner peripheral wall 15 and the outer peripheral wall 16 preferably contain ceramics as a main component. The phrase “contain ceramics as a main component” means that a ratio of a mass of ceramics to the mass of the total component is 50% by mass or more.

Each of the partition wall 18, the inner peripheral wall 15 and the outer peripheral wall 16 preferably has a porosity of 10% or less, and more preferably 5% or less, and even more preferably 3% or less, although not particularly limited thereto. Further, the porosity of the partition wall 18, the inner peripheral wall 15 and the outer peripheral wall 16 may be 0%. The porosity of the partition wall 18, the inner peripheral wall 15 and the outer peripheral wall 16 of 10% or less can lead to improvement of thermal conductivity.

The partition wall 18, the inner peripheral wall 15 and the outer peripheral wall 16 preferably contain SiC (silicon carbide) having high thermal conductivity as a main component. Examples of such a material includes Si-impregnated SiC, (Si+Al) impregnated SiC, a metal composite SiC, recrystallized SiC, Si₃N₄, SiC, and the like. Among them, Si-impregnated SiC and (Si+Al) impregnated SiC are preferably used because they can allow production at lower cost and have high thermal conductivity.

A cell density (that is, the number of cells 17 per unit area) in the cross section of the hollow pillar shaped honeycomb structure perpendicular to the flow path direction of the first fluid is preferably in a range of from 4 to 320 cells/cm², although not particularly limited thereto. The cell density of 4 cells/cm² or more can sufficiently ensure the strength of the partition wall 18, hence the strength of the hollow pillar shaped honeycomb structure itself and effective GSA (geometrical surface area). Further, the cell density of 320 cells/cm² or less can allow prevention of an increase in a pressure loss when the first fluid flows.

The hollow pillar shaped honeycomb structure preferably has an isostatic strength of more than 5 MPa, and more preferably 10 MPa or more, and still more preferably 15 MPa or more, although not particularly limited thereto. The isostatic strength of the hollow pillar shaped honeycomb structure of 5 MPa or more can lead to the hollow pillar shaped honeycomb structure having improved durability. The isostatic strength of the hollow pillar shaped honeycomb structure can be measured according to the method for measuring isostatic fracture strength as defied in the JASO standard M505-87 which is a motor vehicle standard issued by Society of Automotive Engineers of Japan, Inc.

A diameter (an outer diameter) of the outer peripheral wall 16 in the cross section in direction perpendicular to the flow path direction of the first fluid may preferably be from 20 to 200 mm, and more preferably from 30 to 100 mm, although not particularly limited thereto. Such a diameter can allow improvement of heat recovery efficiency. Also, the size of the heat exchanger can be made compact. When the shape of the outer peripheral wall 16 is not circular, the diameter of the largest inscribed circle that is inscribed in the cross-sectional shape of the outer peripheral wall 16 is defined as the diameter of the outer peripheral wall 16.

Further, a diameter of the inner peripheral wall 15 in the cross section in the direction perpendicular to the flow path direction of the first fluid may preferably be from 20 to 90 mm, and more preferably from 30 to 80 mm, although not particularly limited thereto. When the cross-sectional shape of the inner peripheral wall 15 is not circular, the diameter of the largest inscribed circle that is inscribed in the cross-sectional shape of the inner peripheral wall 15 is defined as the diameter of the inner peripheral wall 15.

The hollow pillar shaped honeycomb structure preferably has a thermal conductivity of 50 W/(m·K) or more at 25° C., and more preferably from 100 to 300 W/(m·K), and even more preferably from 120 to 300 W/(m K), although not particularly limited thereto. The thermal conductivity of the hollow pillar shaped honeycomb structure 10 in such a range can lead to an improved thermal conductivity and can allow the heat inside the hollow pillar shaped honeycomb structure to be efficiently transmitted to the outside. It should be noted that the value of thermal conductivity is a value measured according to the laser flash method (JIS R 1611-1997).

In the case where an exhaust gas as the first fluid flows through the cells 17 in the hollow pillar shaped honeycomb structure, a catalyst may be supported on the partition wall 18 of the pillar shaped honeycomb structure. The supporting of the catalyst on the partition wall 18 can allow CO, NOx, HC and the like in the exhaust gas to be converted into harmless substances through catalytic reaction, and can also allow reaction heat generated during the catalytic reaction to be utilized for heat exchange. Preferable catalysts include those containing at least one element selected from the group consisting of noble metals (platinum, rhodium, palladium, ruthenium, indium, silver and gold), aluminum, nickel, zirconium, titanium, cerium, cobalt, manganese, zinc, copper, tin, iron, niobium, magnesium, lanthanum, samarium, bismuth, and barium. Any of the above-listed elements may be contained as a metal simple substance, a metal oxide, or other metal compound.

A supported amount of the catalyst (catalyst metal+support) may preferably be from 10 to 400 g/L, although not particularly limited thereto. Further, when using the catalyst containing the noble metal(s), the supported amount may preferably be from 0.1 to 5 g/L, although not particularly limited thereto. The supported amount of the catalyst (catalyst metal+support) of 10 g/L or more can easily achieve catalysis. Also, the supported amount of the catalyst (catalyst metal+support) of 400 g/L or less can allow suppression of both an increase in a pressure loss and an increase in a manufacturing cost. The support refers to a carrier on which a catalyst metal is supported. Examples of the supports include those containing at least one selected from the group consisting of alumina, ceria and zirconia.

### (2. First Outer Cylindrical Member)

The first outer cylindrical member 20 is a cylindrical member that has an inflow port 21a and an outflow port 21b for the first fluid and is fitted to the outer peripheral surface 12 of the heat recovery member 10.

As used herein, the “fitted” means that members are fixed in a state of being suited to each other. Therefore, the fitting of the heat recovery member 10 and the first outer cylindrical member 20 encompasses cases where the heat recovery member 10 and the first outer cylindrical member 20 are fixed to each other by a fixing method based on fitting such as clearance fitting, interference fitting and shrinkage fitting, as well as by brazing, welding, diffusion bonding, and the like.

It is preferable that the axial direction of the first outer cylindrical member 20 coincides with the axial direction of the heat recovery member 10, and the central axis of the first outer cylindrical member 20 coincides with the central axis of the heat recovery member 10.

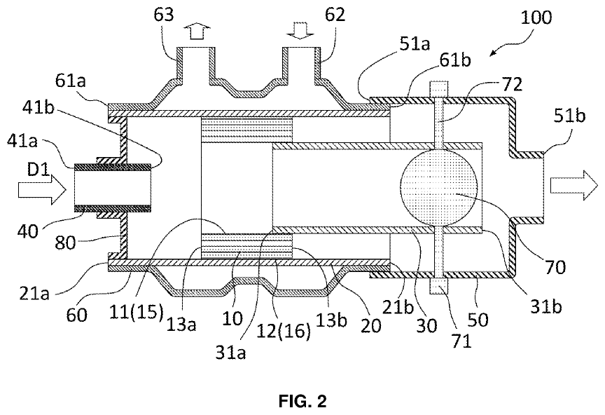

Also, the diameter (outer diameter and inner diameter) of the first outer cylindrical member 20 may be uniform in the axial direction, but the diameter of at least a portion (for example, at least one end side in the axial direction) may be decreased or increased. For example, as shown in FIG. 1A, the diameter of the axial upstream end portion of the first outer cylindrical member 20 is decreased and the axial upstream end portion is connected to the second inner cylindrical member 40, so that the flow path for the first fluid can be formed on the upstream side of the inflow end face 13a of the heat recovery member 10. Further, as shown in FIG. 2, when the diameter of the first outer cylindrical member 20 is uniform in the axial direction, a ring-shaped member for connecting the inflow port 21a side of the first outer cylindrical member 20 to the second inner cylindrical member 40 is provided, so that the flow path for the first fluid can be formed on the upstream side of the inflow end face 13a of the heat recovery member 10.

The first outer cylindrical member 20 may preferably have an inner surface shape corresponding to the outer peripheral surface 12 of the heat recovery member 10. Since the inner surface of the first outer cylindrical member 20 is in direct contact with the outer peripheral surface 12 of the heat recovery member 10, the thermal conductivity is improved and the heat in the heat recovery member 10 can be efficiently transferred to the first outer cylindrical member 20.

In terms of improvement of the heat recovery efficiency, a higher ratio of an area of a portion circumferentially covered with the first outer cylindrical member 20 in the outer peripheral surface 12 of the heat recovery member 10 to the total area of the outer peripheral surface 12 of the heat recovery member 10 is preferable. Specifically, the area ratio is preferably 80% or more, and more preferably 90% or more, and even more preferably 100% (that is, the entire outer peripheral surface 12 of the heat recovery member 10 is circumferentially covered with the first outer cylindrical member 20).

It should be noted that the term “the outer peripheral surface 12” as used herein refers to a surface of the heat recovery member 10, which is parallel to the flow path direction of the first fluid, and does not include surfaces (the inflow end face 13a and the outflow end face 13b) of the heat recovery member 10, which are perpendicular to the flow path direction of the first fluid.

The first outer cylindrical member 20 is preferably made of a metal in terms of manufacturability, although not particularly limited thereto. Further, the metallic first outer cylindrical member 20 is also preferable in that it can be easily welded to other members such as a second inner cylindrical member 70. Examples of the material of the first outer cylindrical member 20 that can be used herein include stainless steel, titanium alloys, copper alloys, aluminum alloys, brass and the like. Among them, the stainless steel is preferable because it has high durability and reliability and is inexpensive.

The first outer cylindrical member 20 preferably has a thickness of 0.1 mm or more, and more preferably 0.3 mm or more, and still more preferably 0.5 mm or more, although not particularly limited thereto. The thickness of the first outer cylindrical member 20 of 0.1 mm or more can ensure durability and reliability. The thickness of the first outer cylindrical member 20 is preferably 10 mm or less, and more preferably 5 mm or less, and still more preferably 3 mm or less. The thickness of the first outer cylindrical member 20 of 10 mm or less can reduce thermal resistance and improve thermal conductivity.

### (3. First Inner Cylindrical Member)

The first inner cylindrical member 30 is a cylindrical member that has an inflow port 31a and an outflow port 31b for the first fluid and is fitted to the inner peripheral surface 11 of the heat recovery member 10. Here, the first inner cylindrical member 30 may be directly fitted to the inner peripheral surface 11 of the heat recovery member 10, or may be fitted indirectly via another member such as a seal member.

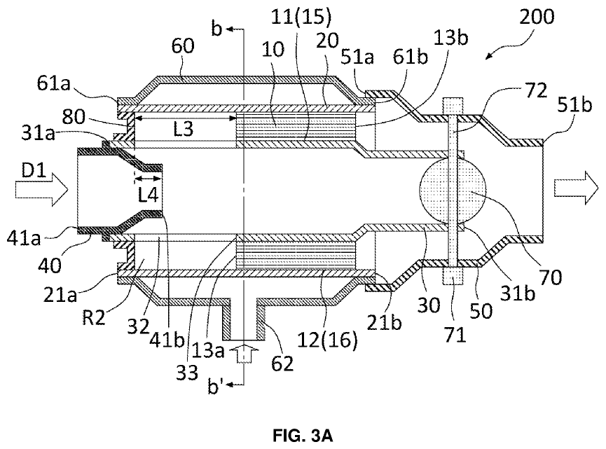

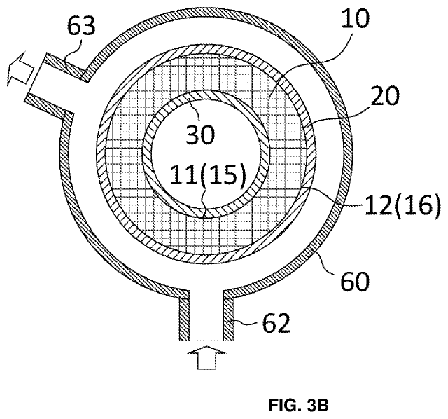

The axial direction of the first inner cylindrical member 30 preferably coincides with that of the heat recovery member 10, and the central axis of the first inner cylindrical member 30 preferably coincides with that of the heat recovery member 10. Also, the diameter (outer diameter and inner diameter) of the first inner cylindrical member 30 may be uniform in the axial direction (e.g., FIG. 1A), but the diameter of at least a portion (e.g., the outflow port 31b side) may be decreased or increased (e.g., FIG. 3A).

The inflow port 31a of the first inner cylindrical member 30 is positioned between the inflow end face 13a and the outflow end face 13b of the heat recovery member 10 based on a flow direction D1 of the first fluid as a reference. By providing the inflow port 31a of the first inner cylindrical member 30 at such a position, the first inner cylindrical member 30 can be fixed to the inner peripheral surface 11 of the heat recovery member 10, and a flow path for the first fluid can be ensured during the non-heat recovery mode. Further, it is possible to suppress narrowing of the flow path of the first fluid during the heat recovery mode, so that the pressure loss is difficult to increase.

The first inner cylindrical member 30 is preferably made of a metal in terms of manufacturability, although not particularly limited thereto. Examples of the material of the first inner cylindrical member 30 that can be used herein include stainless steel, titanium alloys, copper alloys, aluminum alloys, brass and the like. Among them, the stainless steel is preferable because it has high durability and reliability and is inexpensive.

The first inner cylindrical member 30 preferably has a thickness of 0.1 mm or more, and more preferably 0.3 mm or more, and still more preferably 0.5 mm or more, although not particularly limited thereto. The thickness of the first inner cylindrical member 30 of 0.1 mm or more can ensure durability and reliability. The thickness of the first inner cylindrical member 30 is preferably 10 mm or less, and more preferably 5 mm or less, and still more preferably 3 mm or less. The thickness of the first inner cylindrical member 30 of 10 mm or less can reduce the weight of the heat exchanger 100.

(4. Second Inner Cylindrical member)

The second inner cylindrical member 40 is a cylindrical member that has an inflow port 41a and an outflow port 41b for the first fluid.

The axial direction of the second inner cylindrical member 40 preferably coincides with that of the heat recovery member 10, and the central axis of the second inner cylindrical member 40 preferably coincides with that of the heat recovery member 10. Also, the diameter (outer diameter and inner diameter) of the second inner cylindrical member 40 may be uniform in the axial direction, but the diameter of at least a portion (e.g., the outflow port 41b side) may be decreased or increased.

The second inner cylindrical member 40 has a portion arranged at a space so as to form the flow path for the first fluid on a radially inner side of the first outer cylindrical member 20. That is, the second inner cylindrical member 40 has a portion having an outer diameter smaller than the inner diameter of the first outer cylindrical member 20.

Further, the outflow port 41b of the second inner cylindrical member 40 is located on an upstream side of the inflow end face 13a of the heat recovery member 10 based on the flow direction D1 of the first fluid as a reference. By providing the outflow port 41b of the second inner cylindrical member 40 at such a position, the flow of the first fluid (exhaust gas) flowing out through the outflow port 41b of the second inner cylindrical member 40 can be prevented from being turned back during the heat recovery mode. Therefore, during the heat recovery mode, an increase in pressure loss (flow path resistance) can be sufficiently suppressed, so that damage or bursting of the heat exchanger 100 is difficult to occur. Moreover, the length of the second inner cylindrical member 40 can be shortened, so that the weight of the heat exchanger 100 and the production cost can be reduced.

The inner diameter of the outflow port 41b of the second inner cylindrical member 40 is smaller than that of the inflow port 31a of the first inner cylindrical member 30. By thus controlling the inner diameter of the outflow port 41b of the second inner cylindrical member 40, the first fluid flowing out through the outflow port 41b of the second inner cylindrical member 40 tends to flow smoothly into the first inner cylindrical member 30 during the non-heat recovery mode. Therefore, heat is difficult to be transferred to the hollow heat recovery member 10, so that the heat shielding performance can be improved.

A difference between the inner diameter of the outflow port 41b of the second inner cylindrical member 40 and the inner diameter of the inflow port 31a of the first inner cylindrical member 30 is preferably 1 to 20 mm, and more preferably 1 to 10 mm, although it is not particularly limited thereto. By controlling the difference between the diameters to such a range, the above effects can be stably ensured.

A distance between the inflow port 41a of the second inner cylindrical member 40 and the inflow port 21a of the first outer cylindrical member 20 in the flow direction D1 of the first fluid (the axial direction of the first outer cylindrical member 20 and the second inner cylindrical member 40) is preferably 20 mm or less, and more preferably 1 to 15 mm, and even more preferably 5 to 10 mm. By setting the distance to 20 mm or less, the overall length of the heat exchanger 100 can be reduced and the heat exchanger 100 can be made compact. In particular, when connecting the first outer cylindrical member 20 to the second inner cylindrical member 40 by brazing and welding, the strength of the welded portion can be increased by setting that distance to 20 mm or less.

The second inner cylindrical member 40 preferably has a streamlined structure having a diameter gradually decreasing toward the outflow port 41b (for example, a structure of a second inner cylindrical member 40 of a heat exchanger 200 according to Embodiment 2 described below). Such a structure can enhance the effect that the first fluid flowing out thought the outflow port 41b of the second inner cylindrical member 40 tends to flow smoothly into the first inner cylindrical member 30 during the non-heat recovery mode. Moreover, the pressure loss when the fluid passes through the second inner cylindrical member 40 can be reduced.

Although the shape of the outflow port 41b of the second inner cylindrical member 40 is not particularly limited, it is preferably polygonal or elliptical. Such a structure can stably enhance the effect that the first fluid flowing out through the outflow port 41b of the second inner cylindrical member 40 tends to flow smoothly into the first inner cylindrical member 30 during the non-heat recovery mode.

Based on the flow direction D1 of the first fluid as a reference, a ratio L2/L1 of a flow direction length L2 from the outflow port 41b of the second inner cylindrical member 40 to a position corresponding to an upstream end portion of a space region R1 between the first outer cylindrical member 20 and the second inner cylindrical member 40 formed on an upstream side of the inflow end face 13a of the heat recovery member 10, to a flow direction length L1 of the space region R1 is 0.05 to 0.95. By controlling the ratio L2/L1 to such a range, the flow of the first fluid (exhaust gas) flowing out through the outflow port 41b of the second inner cylindrical member 40 is prevented from being turned back as much as possible during the heat recovery mode, and an increase in pressure loss (flow path resistance) can be sufficiently suppressed. From the viewpoint of stably ensuring the effect, the ratio L2/L1 is preferably 0.1 to 0.9, and more preferably 0.3 to 0.7.

It should be noted that when the flow direction length L1 of the space region R1 varies depending on each position in the direction perpendicular to the flow direction D1 of the first fluid, it means the length of the portion where the length of the flow direction length L1 is the longest in the space region R1.

A method of fixing the second inner cylindrical member 40 is not particularly limited, but the second inner cylindrical member 40 may be fixed to the first cylindrical member 20 as shown in FIG. 1A. Also, as shown in FIG. 2, the second inner cylindrical member 40 may be fixed to a ring-shaped member 80. The fixing method includes, but not limited to, a fixing method by fitting such as clearance fitting, interference fitting and shrinkage fitting, as well as by brazing, welding, diffusion bonding, and the like.

The second inner cylindrical member 40 is preferably made of a metal in terms of manufacturability, although not particularly limited thereto. Examples of the material of the second inner cylindrical member 40 that can be used herein include stainless steel, titanium alloys, copper alloys, aluminum alloys, brass and the like. Among them, the stainless steel is preferable because it has high durability and reliability and is inexpensive.

The second inner cylindrical member 40 preferably has a thickness of 0.1 mm or more, and more preferably 0.3 mm or more, and still more preferably 0.5 mm or more, although not particularly limited thereto. The thickness of the second inner cylindrical member 40 of 0.1 mm or more can ensure durability and reliability. The thickness of the second inner cylindrical member 40 is preferably 10 mm or less, and more preferably 5 mm or less, and still more preferably 3 mm or less. The thickness of the second inner cylindrical member 40 of 10 mm or less can reduce the weight of the heat exchanger 100.

### (5. Tubular Member)

The tubular member 50 is a member connected to the outflow port 21b side of the first outer cylindrical member 20. Further, the tubular member 50 has a portion arranged at a space so as to form the flow path for the first fluid on the radially outer side of the first inner cylindrical member 30.

The connection of the tubular member 50 to the first outer cylindrical member 20 may be either direct or indirect. In the case of indirect connection, for example, the second outer cylindrical member 60 or the like may be arranged between the first outer cylindrical member 20 and the tubular member 50.

The tubular member 50 has an inflow port 51a and an outflow port 51b.

The axial direction of the tubular member 50 preferably coincides with that of the heat recovery member 10, and the central axis of the tubular member 50 preferably coincides with that of the heat recovery member 10. Further, the diameter (outer diameter and inner diameter) of the tubular member 50 may be uniform over the axial direction, but the diameter of at least a portion may be decreased or increased.

The tubular member 30 is preferably made of a metal in terms of manufacturability, although not particularly limited thereto. Examples of the material of the tubular member 20 that can be used herein include stainless steel, titanium alloys, copper alloys, aluminum alloys, brass and the like. Among them, the stainless steel is preferable because it has high durability and reliability and is inexpensive.

The tubular member 50 preferably has a thickness of 0.1 mm or more, and more preferably 0.3 mm or more, and still more preferably 0.5 mm or more, although not particularly limited thereto. The thickness of the tubular member 50 of 0.1 mm or more can ensure durability and reliability. The thickness of the tubular member 50 is preferably 10 mm or less, and more preferably 5 mm or less, and still more preferably 3 mm or less. The thickness of the tubular member 50 of 10 mm or less can reduce the weight of the heat exchanger 100.

### (6. Second Outer Cylindrical Member)

The second outer cylindrical member 60 is a cylindrical member arranged at a space on a radially outer side of the first outer cylindrical member 20. A second fluid can flow between the second outer cylindrical member 60 and the first outer cylindrical member 20.

The second outer cylindrical member 60 has an inflow port 61a and an outflow port 61b.

The axial direction of the second outer cylindrical member 60 preferably coincides with that of the heat recovery member 10 and the central axis of the second outer cylindrical member 60 preferably coincides with that of the heat recovery member 10.

The second outer cylindrical member 60 is preferably connected to both a feed pipe 62 for feeding the second fluid to a region between the second outer cylindrical member 60 and the first outer cylindrical member 20, and a discharge pipe 63 for discharging the second fluid from a region between the second outer cylindrical member 60 and the first outer cylindrical member 20. The feed pipe 62 and the discharge pipe 63 are preferably provided at positions corresponding to both axial end portions of the heat recovery member 10, respectively.

The feed pipe 62 and the discharge pipe 63 may extend in the same direction, or may extend in different directions.

The second outer cylindrical member 60 is preferably arranged such that inner peripheral surfaces of both end portions in the axial direction are in direct or indirect contact with the outer peripheral surface of the first outer cylindrical member 20.

A method of fixing the inner peripheral surfaces of both end portions in the axial direction to the outer peripheral surface of the first outer cylindrical member 20 that can be used herein includes, but not limited to, a fixing method by fitting such as clearance fitting, interference fitting and shrinkage fitting, as well as by brazing, welding, diffusion bonding, and the like.

The diameter (outer diameter and inner diameter) of the second outer cylindrical member 60 may be uniform in the axial direction, but the diameter of at least a portion (for example, a central portion in the axial direction, both ends in the axial direction, or the like) of the second outer cylindrical member 60 may be decreased or increased. For example, by decreasing the diameter of the central portion in the axial direction of the second outer cylindrical member 60, the second fluid can spread throughout the outer peripheral direction of the first outer cylindrical member 20 in the second outer cylindrical member 60 on the feed pipe 62 and discharge pipe 63 sides. Therefore, an amount of the second fluid that does not contribute to the heat exchange at the central portion in the axial direction is reduced, so that the heat exchange efficiency can be improved.

The second outer cylindrical member 60 is preferably made of a metal in terms of manufacturability, although not particularly limited thereto. Examples of the material of the second outer cylindrical member 60 that can be used herein include stainless steel, titanium alloys, copper alloys, aluminum alloys, brass and the like. Among them, the stainless steel is preferable because it has high durability and reliability and is inexpensive.

The second outer cylindrical member 60 preferably has a thickness of 0.1 mm or more, and more preferably 0.3 mm or more, and still more preferably 0.5 mm or more, although not particularly limited thereto. The thickness of the second outer cylindrical member 60 of 0.1 mm or more can ensure durability and reliability. The thickness of the second outer cylindrical member 60 is preferably 10 mm or less, and more preferably 5 mm or less, and still more preferably 3 mm or less. The thickness of the second outer cylindrical member 60 of 10 mm or less can reduce the weight of the heat exchanger 100.

### (7. On-Off Valve)

The on-off valve 70 is arranged on the outflow port 31b side of the inner cylindrical member 30.

The on-off valve 70 is rotatably supported by a bearing 71 arranged on a radially outer side of the tubular member 50, and is fixed to a shaft 72 arranged so as to penetrate the tubular member 50 and the inner cylindrical member 30.

The shape of the on-off valve 70 is not particularly limited, but it may be appropriately selected depending on the shape of the inner cylindrical member 30 in which the on-off valve 70 is to be arranged.

The on-off valve 70 can drive (rotate) the shaft 72 by an actuator (not shown). The on-off valve 70 can be opened and closed by rotating the on-off valve 70 together with the shaft 72.

The on-off valve 70 is configured so that the flow of the first fluid inside the inner cylindrical member 30 can be controlled. More particularly, by closing the on-off valve 70 during the heat recovery mode, the first fluid can be circulated through the heat recovery member 10. Further, by opening the on-off valve 70 during the non-heat recovery mode, the first fluid can be circulated from the outflow port 31b side of the inner cylindrical member 30 to the tubular member 50 to discharge the first fluid to the outside of the heat exchanger 100.

### (8. Ring-Shaped Member)

As shown in FIG. 2, the ring-shaped member 80 is a cylindrical member for connecting the inflow port 21a side of the first outer cylindrical member 20 to the second inner cylindrical member 40 so as to form the flow path for the first fluid. The connection position of the second inner cylindrical member 40 to which the ring-shaped member 80 is connected is not particularly limited, and it may be on the inflow port 41a side, on the outflow port 41b side, or near the central portion of the second inner cylindrical member 40, but it may preferably be such that the distance between the inflow port 41a of the second inner cylindrical member 40 and the inflow port 21a of the first outer cylindrical member 20 in the flow direction D1 of the first fluid is preferably 20 mm or less, and more preferably 1 to 15 mm, and more preferably 5 to 10 mm. The reason is as described above.

The connection of the first outer cylindrical member 20 to the second inner cylindrical member 40 by the ring-shaped member 80 may be either direct or indirect. In the case of indirect connection, for example, the second outer cylindrical member 60 or the like may be arranged between the first outer cylindrical member 20 and the ring-shaped member 80.

The axial direction of the ring-shaped member 80 preferably coincides with that of the heat recovery member 10, and the central axis of the ring-shaped member 80 preferably coincides with that of the heat recovery member 10.

Although the shape of the ring-shaped member 80 is not particularly limited, it may have a curved surface structure. Such a structure allows the first fluid to flow smoothly through the heat recovery member 10 during the heat recovery mode (when the on-off valve 70 is closed), thereby reducing the pressure loss.

The ring-shaped member 80 is preferably made of a metal in terms of manufacturability, although not particularly limited thereto. Examples of the material of the ring-shaped member 80 that can be used herein include stainless steel, titanium alloys, copper alloys, aluminum alloys, brass and the like. Among them, the stainless steel is preferable because it has high durability and reliability and is inexpensive.

The ring-shaped member 80 preferably has a thickness of 0.1 mm or more, and more preferably 0.3 mm or more, and still more preferably 0.5 mm or more, although not particularly limited thereto. The thickness of the ring-shaped member 80 of 0.1 mm or more can ensure durability and reliability. The thickness of the ring-shaped member 80 is preferably 10 mm or less, and more preferably 5 mm or less, and still more preferably 3 mm or less. The thickness of the ring-shaped member 80 of 10 mm or less can reduce the weight of the heat exchanger 100.

### (9. First Fluid and Second Fluid)

The first fluid and the second fluid used in the heat exchanger 100 are not particularly limited, and various liquids and gases can be used. For example, when the heat exchanger 100 is mounted on a motor vehicle, an exhaust gas can be used as the first fluid, and water or antifreeze (LLC defined by JIS K2234: 2006) can be used as the second fluid. Further, the first fluid can be a fluid having a temperature higher than that of the second fluid.

### (10. Method for Producing Heat Exchanger 100)

The heat exchanger 100 can be produced in accordance with a method known in the art. For example, when the hollow pillar shaped honeycomb structure is used as the heat exchanger 100, it can be produced in accordance with the method as described below.

First, a green body containing ceramic powder is extruded into a desired shape to prepare a honeycomb formed body. At this time, the shape and density of the cells 17, and lengths and thicknesses of the partition wall 18, the inner peripheral wall 15 and the outer peripheral wall 16, and the like, can be controlled by selecting dies and jigs in appropriate forms. The material of the honeycomb formed body that can be used herein includes the ceramics as described above. For example, when producing a honeycomb formed body containing the Si-impregnated SiC composite as a main component, a binder and water and/or an organic solvent are added to a predetermined amount of SiC powder, and the resulting mixture is kneaded to form a green body, which can be then formed into a honeycomb formed body having a desired shape. The resulting honeycomb formed body can be then dried, and the honeycomb formed body can be impregnated with metal Si and fired under reduced pressure in an inert gas or vacuum to obtain a hollow pillar shaped honeycomb structure having the cells 17 defined by the partition wall 18. The impregnating and firing of metal Si include arranging a lump containing the metal Si and a honeycomb formed body such that they are contacted with each other, and firing them. The contacted point of the lump containing the metal Si in the honeycomb formed body may be the end face, the surface of the outer peripheral wall, or the surface of the inner peripheral wall.

The hollow pillar shaped honeycomb structure is then inserted into the first outer cylindrical member 20, and the first outer cylindrical member 20 is fitted to the outer peripheral wall 16 (outer peripheral surface 12) of the hollow pillar shaped honeycomb structure. Subsequently, the first inner cylindrical member 30 is inserted into the hollow region of the hollow pillar shaped honeycomb structure and the first inner cylindrical member 30 is fitted to the inner peripheral wall 15 (inner peripheral surface 11) of the hollow pillar shaped honeycomb structure. The second outer cylindrical member 60 is then arranged on and fixed to the radially outer side of the first outer cylindrical member 20. The feed pipe 62 and the discharge pipe 63 may be previously fixed to the second outer cylindrical member 60, but they may be fixed to the second outer cylindrical member 60 at an appropriate stage. Next, the second inner cylindrical member 40 is arranged on the predetermined position, and fixed to the first outer cylindrical member 20. Further, when the ring-shaped member 80 is provided, the ring-shaped member 80 is arranged between the second inner cylindrical member 40 and the first outer cylindrical member 20 or the second outer cylindrical member 60 and fixed. The tubular member 50 is then placed on the outflow port 21b side of the first outer cylindrical member 20 and connected. The on-off valve 70 is then attached to the outflow port 31b side of the first inner cylindrical member 30.

In addition, the arranging and fixing (fitting) orders of the respective members are not limited to the above orders, and they may be changed as needed within a range in which the members can be produced. As the fixing (fitting) method, the above method may be used.

### Embodiment 2

FIG. 3A is a cross-sectional view of a heat exchanger according to Embodiment 2 of the present invention, which is parallel to a flow direction of a first fluid. FIG. 3B is a cross-sectional view of the heat exchanger in FIG. 3A taken along the line b-b′.

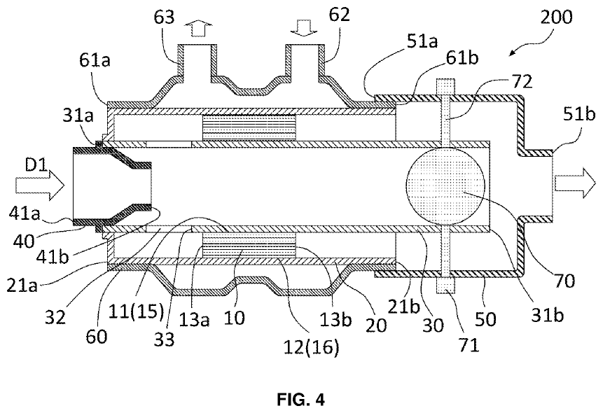

As shown in FIGS. 3A and 3B, a heat exchanger 200 includes a hollow heat recovery member 10, a first outer cylindrical member 20, a first inner cylindrical member 30, and a second inner cylindrical member 40. Also, the heat exchanger 200 can further include a tubular member 50, a second outer cylindrical member 60, an on-off valve 70 and a ring-shaped member 80. The basic structure of the heat exchanger 200 is the same as that of the heat exchanger 100, but the former is different from the latter in that the end portion of the first inner cylindrical member 30 on the side of the inflow port 31a is joined to the second inner cylindrical member 40, and the inner cylindrical member 30 has a through hole 32. Also, in FIG. 3A, the ring-shaped member 80 connects the first outer cylindrical member 20 to the second inner cylindrical member 40, but as shown in FIG. 4, the diameter of the upstream end portion of the first outer cylindrical member 20 in the axial direction may be decreased and that upstream end portion may be connected to the second inner cylindrical member 40. In this case, the end portion of the first inner cylindrical member 30 on the side of the inflow port 31a is joined to the first outer cylindrical member 20 and the second inner cylindrical member 40, and the first inner cylindrical member 30 has the through hole 32. It should be noted that in FIG. 4, the end portion of the first inner cylindrical member 30 on the side of the inflow port 31a is joined to both the first outer cylindrical member 20 and the second inner cylindrical member 40, but it may be joined to one of the first outer cylindrical member 20 or the second inner cylindrical member 40.

The heat exchanger 200 can be produced according to a method known in the art. For example, the heat exchanger 200 can be produced according to the production method of the heat exchanger 100 as described above.

Hereinafter, since the components having the same reference numerals as those appearing in the descriptions of the heat exchanger 100 according to Embodiment 1 of the present invention are the same as the components of the heat exchanger 200 according to Embodiment 2 of the present invention, the descriptions of those components will be omitted.

In the heat exchanger 200, the end portion of the first inner cylindrical member 30 on the side of the inflow port 31a is joined to the first outer cylindrical member 20 and/or the second inner cylindrical member 40, so that the through hole 32 for introducing the first fluid is provided on the upstream side of the inflow end face 13a of the heat recovery member 10.

Further, the outflow port 41b of the second inner cylindrical member 40 is positioned on a radially inner side of the first inner cylindrical member 30, and on the upstream side of the downstream end portion 33 of the through hole 32 of the first inner cylindrical member 30 based on the flow direction D1 of the first fluid as a reference.

The structure as described above can prevent the flow of the first fluid (exhaust gas) that has flowed out through the outflow port 41b of the second inner cylindrical member 40 from being turned back during the heat recovery mode. Therefore, during the heat recovery mode, an increase in pressure loss (flow path resistance) can be sufficiently suppressed, so that damage or bursting of the heat exchanger 200 is difficult to occur. Moreover, the length of the second inner cylindrical member 40 can be shortened, so that the weight of the heat exchanger 200 and the production cost can be reduced. Further, the diameter of the outflow port 41b of the second inner cylindrical member 40 is smaller than that of the first inner cylindrical member 30, so that the first fluid that has flowed out through the outflow port 41b of the second inner cylindrical member 40 is difficult to pass through the through hole 32 during the non-heat recovery mode and tends to flow smoothly through the first inner cylindrical member 30. Therefore, the heat will be difficult to be transferred to the hollow heat recovery member 10, so that the heat shielding performance can be improved.

The shape of the through hole 32 provided in the first inner cylindrical member 30 is not particularly limited, and various shapes such as circular, elliptical, and quadrangular shapes can be used. Also, the number of through holes 32 is not particularly limited, and a plurality of through holes 32 may be provided in the circumferential direction of the first inner cylindrical member 30 or may be provided in the axial direction of the first inner cylindrical member 30. When the plurality of through holes 32 are provided, the above “downstream end portion 33 of the through hole 32 of the first inner cylindrical member 30” means the downstream end portion 33 of the through hole 32 located on the most downstream side of the first inner cylindrical member 30.

Based on the flow direction of the first fluid as a reference, a ratio L4/L3 of a flow direction length L4 from the outflow port 41b of the second inner cylindrical member 40 to a position corresponding to an upstream end portion of a space region R2 between the first outer cylindrical member 20 and the first inner cylindrical member 30 formed on an upstream side of the inflow end face 13a of the heat recovery member 10, to a flow direction length L3 of the space region R2 is 0.05 to 0.95, based on the flow direction of the first fluid as a reference. By controlling the ratio L4/L3 to such a range, the flow of the first fluid (exhaust gas) flowing out through the outlet port 41b of the second inner cylindrical member 40 can be prevented from being turned back as much as possible during the heat recovery mode, so that an increase in pressure loss (flow path resistance) can be sufficiently suppressed. From the viewpoint of stably ensuring that effect, the ratio L4/L3 is preferably 0.1 to 0.8, and more preferably 0.3 to 0.7.

In the heat exchanger 200 as shown in FIGS. 3A and 3B, based on the flow direction of the first fluid as a reference, the central portion of the axial length of the hollow heat recovery member 10 is positioned on the downstream side of the central portion of the first outer cylindrical member 20 and the second outer cylindrical member 60. The inflow end face 13a of the hollow heat recovery member 10 is aligned at the same position as the downstream end portion 33 of the through hole 32 provided in the first inner cylindrical member 30, and the upstream end portion of the through hole 32 is aligned at the same position as the position of the downstream end portion 80 of the ring-shaped member 80. Therefore, the through hole 32 can be provided so as to be long in the axial direction of the first inner cylindrical member 30, so that the effect of suppressing the increase in pressure loss (flow path resistance) during the heat recovery mode can be enhanced. Further, the contact area of the first outer cylindrical member 20 with the first fluid at elevated temperature can be increased, so that the heat transfer to the second fluid can be increased to improve the heat exchange efficiency.

Further, in the heat exchanger 200 shown in FIGS. 3A and 3B, based on the flow direction of the first fluid as a reference, the positions of the downstream end portion of the flow path for the second fluid formed between the first outer cylindrical member 20 and the second outer cylindrical member 60 and the inflow end face 13a of the hollow heat recovery member 10 are aligned with each other, so that the heat exchange performance during the heat recovery mode is sufficiently ensured.

Furthermore, in the heat exchanger 200 shown in FIGS. 3A and 3B, the feed pipe 62 and the discharge pipe 63 are arranged in the circumferential direction orthogonal to the axial direction of the second outer cylindrical member 60. By thus providing the feed pipe 62 and the discharge pipe 63, parts such as an actuator for the on-off valve 70 tend to be installed on the surface of the tubular member 50 between the feed pipe 62 and the discharge pipe 63 while sufficiently ensuring the heat exchange performance during the heat recovery mode, so that the heat exchanger 200 can be made compact.

### DESCRIPTION OF REFERENCE NUMERALS

10 heat recovery member
11 inner peripheral surface
12 outer peripheral surface
13a inflow end face
13b outflow end face
15 inner peripheral wall
16 outer peripheral wall
17 cell
18 partition wall
20 first outer cylindrical member
21a inflow port
21b outflow port
30 first inner cylindrical member
31a inflow port
31b outflow port
32 through hole
33 downstream end portion
40 second inner cylindrical member
41a inflow port
41b outflow port
50 tubular member
51a inflow port
51b outflow port
60 second outer cylindrical member
61a inflow port
61b outflow port
62 feed pipe
63 discharge pipe
70 on-off valve
71 bearing
72 shaft
80 ring-shaped member
100, 200 heat exchanger

1. A heat exchanger, comprising:
a hollow heat recovery member having an inner peripheral surface and an outer peripheral surface in an axial direction, and an inflow end face and an outflow end face for a first fluid in a direction perpendicular to the axial direction;
a first outer cylindrical member having an inflow port and an outflow port for the first fluid, the first outer cylindrical member being fitted to the outer peripheral surface of the heat recovery member;
a first inner cylindrical member having an inflow port and an outflow port for the first fluid, the first inner cylindrical member being fitted to the inner peripheral surface of the heat recovery member, wherein the inflow port is located between the inflow end face and the outflow end face of the heat recovery member, based on a flow direction of the first fluid as a reference; and
a second inner cylindrical member having an inflow port and an outflow port for the first fluid, the outflow port being located on an upstream side of the inflow end face of the heat recovery member based on the flow direction of the first fluid as a reference, wherein the second inner cylindrical member has a portion arranged at a space so as to form a flow path for the first fluid on a radially inner side of the first outer cylindrical member;
wherein the outflow port of the second inner cylindrical member has an inner diameter smaller than that of the inflow port of the first inner cylindrical member,
wherein a ratio L2/L1 of a flow direction length L2 from the outflow port of the second inner cylindrical member to a position corresponding to an upstream end portion of a space region between the first outer cylindrical member and the second inner cylindrical member formed on an upstream side of the inflow end face of the heat recovery member, to a flow direction length L1 of the space region is 0.05 to 0.95, based on the flow direction of the first fluid as a reference.

2. The heat exchanger according to claim 1, further comprising a ring-shaped member for connecting the inflow port side of the first outer cylindrical member to the second inner cylindrical member so as to form the flow path for the first fluid.

3. A heat exchanger, comprising:
a hollow heat recovery member having an inner peripheral surface and an outer peripheral surface in an axial direction, and an inflow end face and an outflow end face for a first fluid in a direction perpendicular to the axial direction;
a first outer cylindrical member having an inflow port and an outflow port for the first fluid, the first outer cylindrical member being fitted to the outer peripheral surface of the heat recovery member;
a first inner cylindrical member having an inflow port and an outflow port for the first fluid, the first inner cylindrical member being fitted to the inner peripheral surface of the heat recovery member, wherein at least one through hole for introducing the first fluid to the inflow end face of the heat recovery member is provided on an upstream side of the inflow end face of the heat recovery member, based on a flow direction of the first fluid as a reference; and
a second inner cylindrical member having an inflow port and an outflow port for the first fluid, the outflow port being located on a radially inner side of the first inner cylindrical member and on an upstream side of a downstream end portion of the through hole of the first inner cylindrical member, based on the flow direction of the first fluid as a reference;
wherein an end portion of the first inner cylindrical member on the inflow port side is connected to the first outer cylindrical member and/or the second inner cylindrical member,
wherein a ratio L4/L3 of a flow direction length L4 from the outflow port of the second inner cylindrical member to a position corresponding to an upstream end portion of a space region between the first outer cylindrical member and the first inner cylindrical member formed on an upstream side of the inflow end face of the heat recovery member, to a flow direction length L3 of the space region is 0.05 to 0.95, based on the flow direction of the first fluid as a reference.

4. The heat exchanger according to claim 3, further comprising a ring-shaped member for connecting the inflow port side of the first outer cylindrical member to the inflow port side of the first inner cylindrical member and/or the second inner cylindrical member so as to form the flow path for the first fluid.

5. The heat exchanger according to claim 1, further comprising a tubular member connected to the outflow port side of the first outer cylindrical member, the tubular member having a portion arranged at a space so as to form the flow path for the first fluid on a radially outer side of the first inner cylindrical member.

6. The heat exchanger according to claim 1, wherein the second inner cylindrical member has a streamlined structure having a diameter gradually decreasing toward the outflow port.

7. The heat exchanger according to claim 1, wherein the outflow port of the second inner cylindrical member is polygonal or elliptical.

8. The heat exchanger according to claim 1, wherein the heat recovery member is a hollow pillar shaped honeycomb structure having an inner peripheral wall, an outer peripheral wall, and a partition wall arranged between the inner peripheral wall and the outer peripheral wall, the partition wall defining a plurality of cells each extending from the inflow end face to the outflow end face to form a flow path for the first fluid.

9. The heat exchanger according to claim 1, further comprising a second outer cylindrical member arranged at a space on a radially outer side of the first outer cylindrical member, wherein a second fluid can be allowed to flow between the second outer cylindrical member and the first outer cylindrical member.

10. The heat exchanger according to claim 1, further comprising an on-off valve arranged on the outflow port side of the first inner cylindrical member.

11. The heat exchanger according to claim 3, further comprising a tubular member connected to the outflow port side of the first outer cylindrical member, the tubular member having a portion arranged at a space so as to form the flow path for the first fluid on a radially outer side of the first inner cylindrical member.

12. The heat exchanger according to claim 3, wherein the second inner cylindrical member has a streamlined structure having a diameter gradually decreasing toward the outflow port.

13. The heat exchanger according to claim 3, wherein the outflow port of the second inner cylindrical member is polygonal or elliptical.

14. The heat exchanger according to claim 3, wherein the heat recovery member is a hollow pillar shaped honeycomb structure having an inner peripheral wall, an outer peripheral wall, and a partition wall arranged between the inner peripheral wall and the outer peripheral wall, the partition wall defining a plurality of cells each extending from the inflow end face to the outflow end face to form a flow path for the first fluid.

15. The heat exchanger according to claim 3, further comprising a second outer cylindrical member arranged at a space on a radially outer side of the first outer cylindrical member, wherein a second fluid can be allowed to flow between the second outer cylindrical member and the first outer cylindrical member.

16. The heat exchanger according to claim 3, further comprising an on-off valve arranged on the outflow port side of the first inner cylindrical member.
